(19) United States
(12) Patent Application Publication
(10) Pub. No.: US 2014/0178664 A1
(43) Pub. Date: Jun. 26, 2014

(54) Yoga Towel

(71) Applicant: John D'Orazio, Glen Ellyn, IL (US)

(72) Inventor: John D'Orazio, Glen Ellyn, IL (US)

(21) Appl. No.: 14/105,901

(22) Filed: Dec. 13, 2013

Related U.S. Application Data
(60) Provisional application No. 61/745,887, filed on Dec. 26, 2012.

(51) Int. Cl. B32B 5/02; B32B 25/16; B32B 5/18

(52) U.S. Cl. CPC B32B 5/02; B32B 5/18; B32B 25/16
USPC 428/220; 428/221; 428/319.3; 428/340; 428/337

(57) ABSTRACT

A yoga towel particularly suited for practicing hot yoga includes a top water absorbing microfiber layer that is laminated to a bottom water impermeable neoprene layer.

This application claims the benefit of U.S. Provisional Application 61/745,887 filed Dec. 26, 2012.

### FIELD OF THE INVENTION

The present invention relates to athletic equipment, particularly to pads used during yoga exercises.

### BACKGROUND OF THE INVENTION

In the practice of yoga, the athlete practices on a floor typically covered by a yoga mat. Typical yoga mats have a single foam layer construction. Often times the underlying floor is a hard surface such as a wooden floor. The yoga mat provides cushioning to the athlete against the hard floor.

In the practice of “hot yoga”, the yoga exercises are practiced in an environment of elevated temperature. In this hot environment, athletes perspire greatly. Using a yoga mat that is water resistant can cause perspiration to run off and/or puddle on the mat. Using a yoga mat that absorbs water for hot yoga can cause an undue amount of perspiration to be absorbed into the yoga mat which results in perspiration passing through the yoga mat and onto the underlying floor. When perspiration is passed onto the underlying floor, such as an underlying wooden floor, the yoga mat can become slippery and slide on the floor during exercise. When used on an underlying carpeted floor, the perspiration that passes through, or runs off, the yoga mat can soak into the carpet and cause hygiene and odor problems in the yoga studio.

The present inventor has recognized that it would be desirable to provide a different pad for the practice of yoga, particularly for the practice of hot yoga that prevented perspiration for penetrating through the pad onto the underlying floor surface.

### SUMMARY OF THE INVENTION

The invention provides a hot yoga towel that provides a cushioned, water absorbing top side layer and an underlying water impermeable bottom side layer. During the practice of hot yoga, the athlete's perspiration is absorbed into the top side layer and prevented from penetrating through to the underlying floor by the water impermeable bottom side layer. Additionally, the bottom side layer of the yoga towel provides an increased grip on the underlying floor and causes the yoga towel to stay flat during exercise.

An exemplary embodiment of the invention provides a microfiber terry cloth top side layer that is laminated onto a neoprene, water impermeable bottom side layer. Preferably, the microfiber of the top side layer has a weight of 400 grams per square meter. The neoprene layer can have a thickness of 2 millimeters. If increased cushioning is desired, either or both of the top and bottom side layers can be increased. The common edges of the top and bottom layers can be surrounded by a piping to provide an attractive, rugged construction resistant to tearing and fraying. The yoga towel can have an overall size in plan of 24 inches by 72 inches.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a plan view of a yoga towel embodiment of the present invention; and

FIG. 2 is a sectional view taken generally along the lines 2-2 of FIG. 1.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

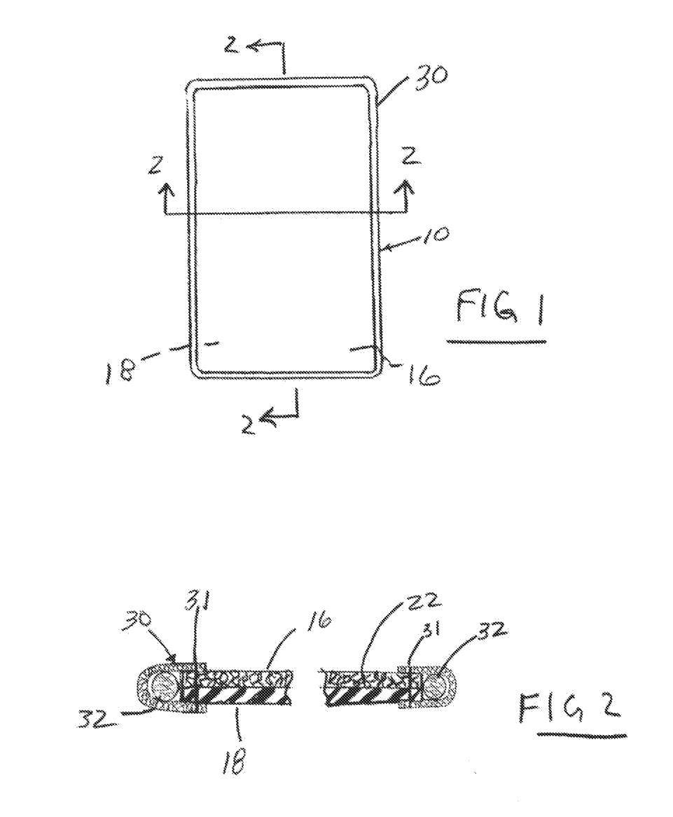

FIG. 1 illustrates a yoga towel 10 according to an embodiment of the invention. The yoga top 10 includes a top side layer 16 and a bottom side layer 18 that is coextensive with the top side layer 16. The top side layer 16 is laminated, adhesively secured or otherwise secured to the bottom side layer 18. Preferably, this lamination or securement is spread throughout an interface area 22 between the two layers 16, 18.

A surrounding hem fabric piece 30 is stitched with stitches 31 through the fabric piece 30 and the two layers 16, 18. A piping cord 32 can be captured by the fabric piece 30 against the outer edges of the two layers 16, 18. The fabric hem piece 30, the stitching 31 and piping cord 32 produce an aesthetically pleasing, rugged edge to the towel 10.

The towel 10 provides an exemplary pad for practicing hot yoga. In this regard, the top layer 16 can be composed of a microfiber terry cloth material that is soft on the athlete's skin but also can absorb a great amount of perspiration. The microfiber terry cloth material can have a weight of 400 grams per square meter. Other fabric materials for the top layer are possible that are soft and absorb water, such as foam or fabric materials are also encompassed by the invention.

The bottom layer 18 can be composed of a water impermeable neoprene to prevent perspiration from penetrating therethrough onto the underlying floor. The neoprene material can be 2 millimeters thick. Other materials for the bottom layer are possible that are water impermeable, such as other polymer, rubber or elastomeric materials are also encompassed by the invention.

The bottom layer 18 being neoprene provides an enhanced gripping friction to prevent the towel 10 from sliding on the underlying floor during exercise, particularly if the underlying floor is a hard surface. The bottom layer 18 can have sufficient weight and stiffness that the towel retains a flat condition on the underlying floor, even during exercises thereon.

From the foregoing, it will be observed that numerous variations and modifications may be effected without departing from the spirit and scope of the invention. It is to be understood that no limitation with respect to the specific apparatus illustrated herein is intended or should be inferred.

I claim as my invention:

1. A yoga towel for practicing yoga at elevated temperatures, comprising
a water absorbing top player;
a water impermeable bottom layer adhered to the top layer.

2. A yoga towel according to claim 1, wherein the top layer comprises a microfiber material.

3. A yoga towel according to claim 1, wherein the bottom layer comprises a neoprene material.

4. A yoga towel according to claim 1, wherein the top layer comprises a fabric material.

5. A yoga towel according to claim 1, wherein the bottom layer comprises a elastomeric material.

6. A yoga towel according to claim 1, wherein the top layer comprises a foam material.

7. A yoga towel according to claim 1, wherein the bottom layer comprises a polymer material.

8. A yoga towel according to claim 1, wherein the top layer comprises a microfiber material having a weight of 400 grams per square meter.

9. A yoga towel according to claim 1, wherein the bottom layer comprises a neoprene material having a 2 millimeter thickness.

10. A yoga towel according to claim 1, wherein the towel has an overall size of 24 inches by 72 inches.
